(19) United States
(12) Patent Application Publication
(10) Pub. No.: US 2012/0018556 A1
(43) Pub. Date: Jan. 26, 2012

(54) Single Use Bead Mill

(76) Inventor: Nathan Starbard, Boston, MA (US)

(21) Appl. No.: 13/248,388

(22) Filed: Sep. 29, 2011

(51) Int. Cl. B02C 23/00

(52) U.S. Cl. 241/101.2

(57) ABSTRACT

The present invention relates to a device that incorporates a single use bead mill that is at least partially sterilized prior to use in the pharmaceutical, biopharmaceutical, biotechnology or related industries and is used for the disruption of cells or for homogenization within one or more fluid streams and is connected to a bioreactor, fermentor, container or process by way of single use tubing, connectors and/or various fluid flow components.

### TECHNICAL FIELD

The present invention concerns a device incorporating a single use bead mill, alternatively called a ball mill, that is sterilized prior to use in the pharmaceutical, biopharmaceutical, biotechnology or related fields.

### BACKGROUND ART

Biotechnology, pharmaceutical and related industries have historically used stainless steel, or otherwise reusable, processes and devices. Re-useable processes must be cleaned and sterilized between batches. The cleaning and sterilization usually requires the use of steam and/or chemicals to accomplish the task. Additionally, for regulated products such as pharmaceuticals, the sterilization process has to be validated to show that it could repeatedly sterilize the device. The cleaning and sterilization processes and the validation are time consuming and expensive and cannot be varied without a new validation. Re-useable processes also have significantly higher startup costs in material and installation, and often require a much larger footprint.

As a result, in recent years these industries are increasingly moving towards the use of single use (disposable) containers, filters, tubing, flow path components and ancillary equipment in their research, manufacturing and processing of fluids. The use of single use devices eliminates or minimizes the need for cleaning and sterilizing equipment between batches.

Bead mills are primarily used for cell disruption downstream from fermentors or bioreactors to release target materials contained within the cells.

### SUMMARY

Re-usable equipment and technologies require cleaning and sterilization, increased start-up costs and costly validations. They also create difficulties for technology transfer and can limit both scalability and reproducibility.

The present invention advantageously brings the benefits of single use technology to cell disruption to allow the user to safely process a fluid and/or biopharmaceutical product without the risk of contamination and thereby also reducing the cleaning and/or validation costs associated with conventional methods. Technology transfer, the process of moving, transferring or duplicating processes in different locations, is made significantly easier through the use of such a device.

### BRIEF DESCRIPTION OF THE DRAWINGS

FIG. 1 Shows a single use bead mill with a cross-sectional view of the milling chamber. The fluid inlet and outlet are formed as aseptic connectors.

FIG. 2 Shows a cross-sectional view of a single use bead mill with the single use portion of the bead mill primarily comprised of the fluid inlet and outlet, milling chamber and agitation disks as it would be attached to the re-useable portion of the equipment.

FIG. 3 Shows a single use bead mill with a cross-sectional view of the milling and heat exchange chambers.

FIG. 4 Shows a locking tab configuration that may be used to connect the single use portion of the bead mill with the re-useable portion of the bead mill, usually at the rotor.

FIG. 5 Shows a threaded configuration that may be used to connect the single use portion of the bead mill with the re-useable portion of the bead mill, usually at the rotor.

FIG. 6 Shows a single use bead mill with a heat exchange chamber. The fluid inlet and outlet are connected through tubing connectors to sections of tubing that end with aseptic connectors.

FIG. 7 Shows an aerial view of a single use bead mill with a heat exchange chamber. An open slot in the re-useable heat exchange chamber allows for insertion and locking into place of the single use milling chamber with protruding fluid inlet and outlet.

### DESCRIPTION OF THE EMBODIMENTS

Current industry generally uses bead mills formed almost entirely of a metallic composition such as stainless steel. Re-useable bead mills may often incorporate other metals such as titanium or aluminum and also ceramics. This is primarily for the longevity and clean-ability of the bead mill. As the present invention is designed for a single use, longevity and clean-ability are not required traits of certain components of the present invention. Polymers and plastics are appropriate materials for single use bead mills.

In the preferred embodiment of the invention, only a portion of the bead mill is designed for single use. The single use components of the device are primarily comprised of the fluid contact areas including the inlet 3, outlet 4, milling chamber 6, agitation discs 5 and other fluid contact surfaces. The motor 1, all or part of the exterior rotor 7, outer casing and/or heat exchange chamber 9, base and controls 2 as well as ancillary non-fluid contact components are re-used and are designed as fixed equipment, usually formed of a metallic or ceramic composition.

The rotor 7 of the bead mill rapidly turns to create the force and motion that operates in conjunction with the beads and internal components of the bead mill to perform the milling of the feed inside of the milling chamber 6. In the preferred embodiment of the present invention the rotor is the preferred interface between the single use and re-useable portions of the bead mill. In one embodiment of the invention one piece 8, 12 of the rotor is part of the single use portion of the bead mill. It is attached to the re-useable piece of the rotor 7, 13 by some means such as threads or locking tabs. The single use portion of the rotor 8 is preferably formed of a polymeric composition while the re-useable portion of the rotor 7 is preferably formed of a metallic composition. Stainless steel or other metallic reinforcement may be used in the primarily polymeric single use portion of the rotor.

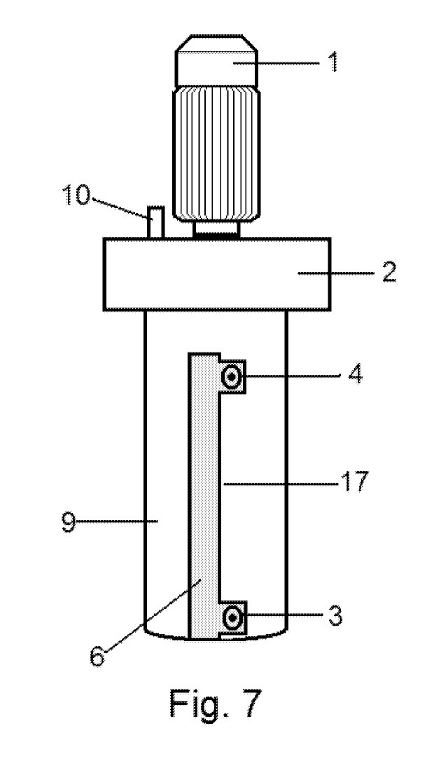

There are various adaptations known to prior art that are used in bead mill designs to increase milling efficiency, capacity, speed or to provide some other feature or benefit to the device that may be incorporated into the present invention including various chamber 6 or agitation disc designs 5, baffles, an integrated heat exchange chamber 9, placement and/or angle of the inlet 3 and/or outlet 4, the shapes and/or locations of various components and so forth. Bead mills may incorporate a heat transfer mechanism to dissipate heat generated by the milling operation. The usual method of heat transfer is through a secondary chamber 9 that surrounds the primary milling chamber 6. The heat exchange chamber is normally filled with a cold fluid to cool the milling chamber. The heat exchange chamber is not in contact with the fluid product and therefore may be formed as either part of the single use device or as part of the re-useable equipment. The preferred embodiment of the present invention is that in which the heat exchanger chamber is formed as part of the re-useable portion of the bead mill. In one embodiment of the present invention shown in FIG. 7 the re-useable heat exchange chamber has a positioning and/or locking grove 17 to accommodate the insertion of the single use milling chamber with a protruding milling chamber inlet and outlet.

The single use portions of the device of the present invention are preferably formed either entirely or predominantly of a polymeric composition such as polypropylene (PP); polyamide (PA); polyethylene terephthalate (PET); polysulfone (PS); polyethersulfone (PES); polyvinyl chloride (PVC), polycarbonate (PC), polyvinylidene fluoride (PVDF), polyetheretherketone (PEEK), polytetrafluoroethylene (PTFE), polyurethane (PU); polyethylene (including ultrahigh molecular weight polyethylene, linear low density polyethylene, ultralow, low or medium density polyethylene); ethylene vinyl alcohol (EVOH); polyvinyl acetate (PVA); ethylene vinyl acetate (EVA); ethylene vinyl acetate copolymers; films and multilayered laminates of different thermoplastics; as well as other polymers and plastics (including thermoplastic polymers, thermoplastic elastomers, homopolymers, copolymers, block copolymers, graft copolymers, random copolymers, alternative copolymers, terpolymers, metallocene polymers) and derivatives or mixtures thereof. Such materials are available from a wide range of chemical manufacturers. Metals, including stainless steel, titanium and aluminum, may also be used to form all or a part of the single use components of the invention. Metals, primarily stainless steel, are used to construct the re-useable fixed equipment of the present invention that may include the rotor 7, motor 1, heat exchange chamber 9, base and controls 2 and so forth. Beads used in conjunction with the bead mill may be formed of any suitable material including glass, ceramic, metals, plastics and polymers and so forth.

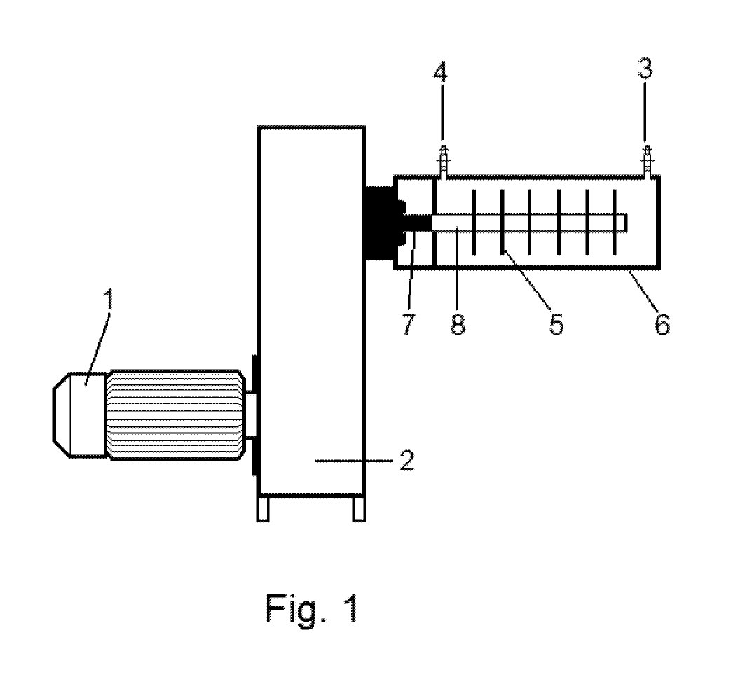

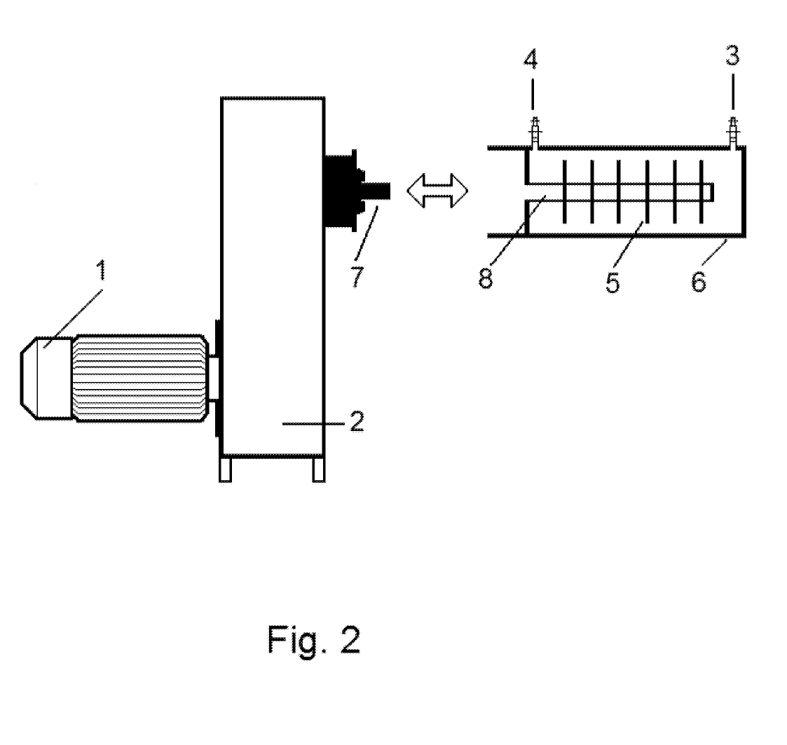

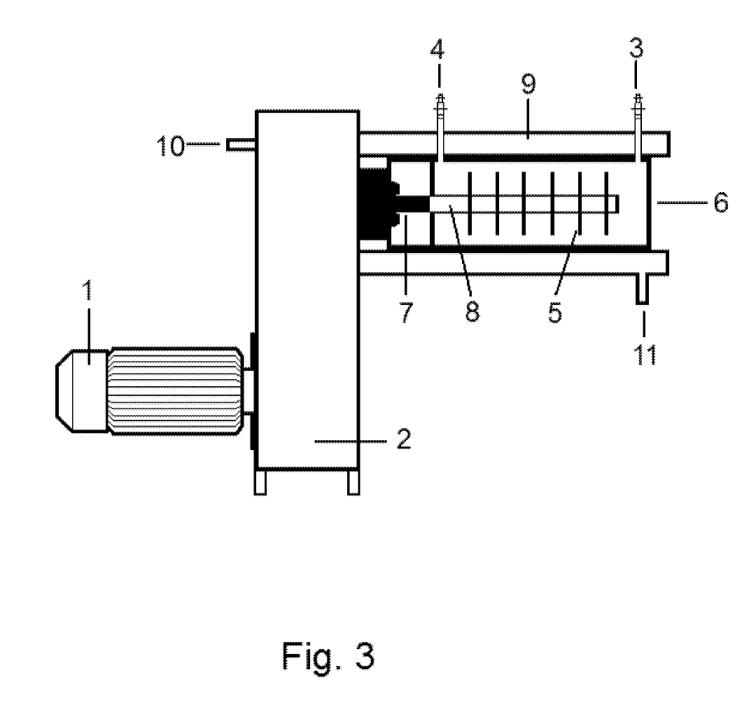

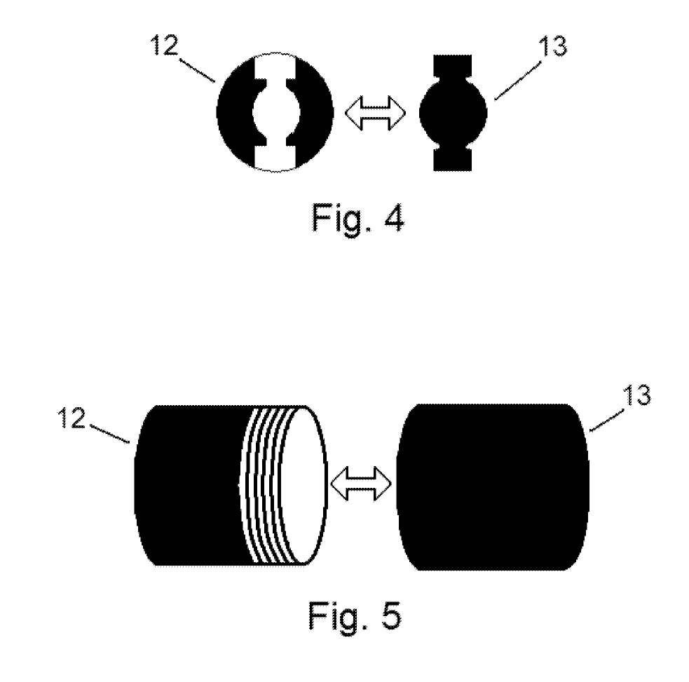

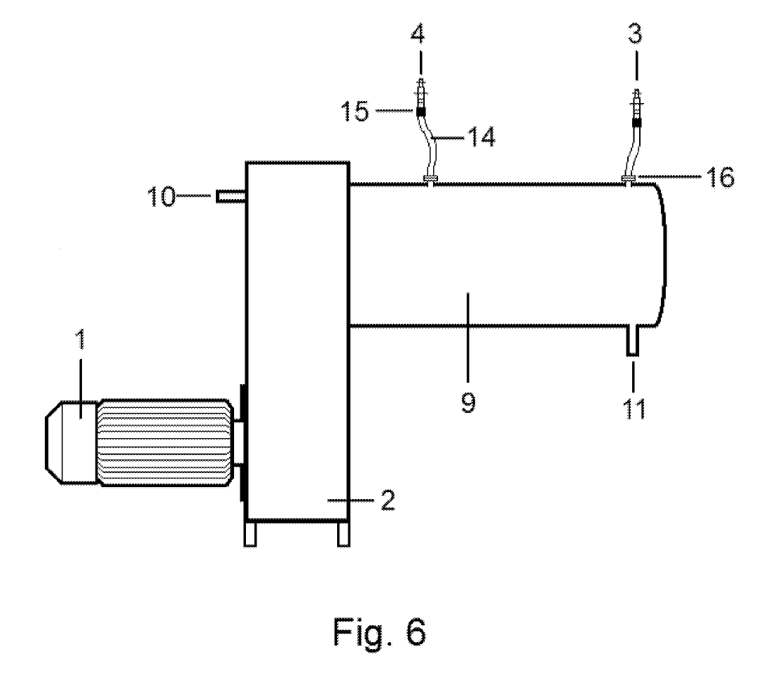

In the preferred embodiment of the present invention the bead mill is incorporated with or used in conjunction with aseptic (sterile) connectors such that the device may be attached to a process or container without the risk of contamination or use of a special area or procedure, such as under a hood in a clean room. Aseptic connectors are increasingly used within industry to connect containers, sampling devices, filters, tubing 14, sections of a process and so forth. Aseptic connectors are available from a variety of suppliers to the pharmaceutical and biotechnology industries including Sartorius Stedim Biotech SA of France; Colder Products Company of St. Paul, Minn.; Millipore Corp. of Billerica, Mass.; Pall Corp. of Port Washington, N.Y. and GE Healthcare of Fairfield, Conn. The bead mill may directly incorporate aseptic connectors as its inlet and outlet as is shown in FIG. 1. In this embodiment the connectors may be formed as part of the bead mill or permanently attached directly to the milling chamber. The bead mill may also indirectly incorporate aseptic connectors such as when they are attached via tubing 14 and/or fluid flow components or connectors 16 to the bead mill inlet and/or outlet as shown in FIG. 6. Fluid flow components and fittings that may be used in the path of the inlet and/or outlet of the device may include connectors such as Luer, Colder or other such connectors common to industry, valves, clamps, tees, hose barbs, sanitary connections and so forth.

The preferred embodiment of the present invention uses aseptic (sterile) connectors that are initially a closed system to allow for device unpackaging and attachment while maintaining sterility. Such connectors include the Lynx Connector from Millipore Corp.; the Opta Connector from Sartorius Stedim Biotech SA; the ReadyMate Connector from GE Healthcare; the Kleenpak Connector from Pall Corp.; and so forth. These connectors are of a design such that the disconnected ends are initially a sterile barrier. There are two matching pieces of the connector with one being attached to a device or process and the other being attached to the item desired to be connected, in this case the device of the invention. Upon combining the two ends of the connector the flow path is generally opened by way of some means such as actuation, use of a membrane barrier and so forth. The fluid flow path is not exposed and therefore remains sterile.

In addition to being a unique device connected to a container or process, another embodiment of the present invention is as a single use bead mill pre-connected to a part of the process, such as a container or bioreactor, by way of tubing, flow path components and/or connectors. The entire section of the process including the container, the present invention and other ancillary components such as filters, sampling devices, additional tubing, sensors and so forth are sterilized together through a method such as irradiation, autoclaving or exposure to ethylene oxide. An aseptic connector may not be required in this embodiment as the invention is already connected to the process or container prior to sterilization. This embodiment is most applicable when using an entirely disposable polymeric flow path.

The present invention is most commonly sterilized by exposure to irradiation. The two forms of irradiation most commonly used in the pharmaceutical and biotechnology industries for sterilization are exposure to gamma rays and cathode rays, also called electron beams or e-beams. X-rays and ultraviolet (UV) light are other sources of radiation that may also be used in some instances. Exposure to ethylene oxide (ETO) and autoclaving may also be used for sterilization. Sterilization methods commonly used for the sterilization of re-useable equipment such as the use of steam and/or chemicals may also be used for sterilization of the present device. The present invention may be sterilized through a combination of techniques. For example, an irradiated bead mill may be fitted with autoclaved connectors or tubing assemblies under a hood. The preferred embodiment of the invention is that in which the single use portion of the bead mill is assembled with aseptic connectors, tubing 14, instrumentation, flow path components 16 and other material requirements of the application prior to the entire device being sterilized, usually by gamma irradiation.

Materials have different levels of compatibility with respect to exposure to irradiation. Many materials turn brittle, discolor or crack following exposure to irradiation used for sterilization. Materials may be altered or blended to increase the contact dosage able to be applied. An irradiation compatible material is one that is able to perform its intended function following sterilization by irradiation. As the intended function may differ, a material may be considered compatible for one application of the device, while not compatible for another application. Furthermore, some materials may be more or less affected by one form of irradiation used for sterilization than another.

The preferred method of manufacturing the device is by molding the individual components of the bead mill by common molding techniques prior to joining the components together. Additional components such as tubing assemblies, single use containers, fluid flow components and aseptic connectors not fully incorporated as part of the device are added. The desired type and quantity of beads are added during device manufacturing by the device manufacturer or prior to device usage by the end-user. The device should be manufactured and/or assembled in a clean room or otherwise sterile and/or sufficiently clean environment so as to minimize the introduction of contaminants and particulates. The device is sterilized prior to usage.

The invention may be wirelessly enabled. The wireless communications device may be a RFID tag having a communication and storage or memory component or other wireless devices such as Bluetooth or Zigbee wireless enabled communications devices. By wirelessly enabling the device one can track the device history or important information, such as manufacture date, lot number, shelf life, sterilization date and the like. The invention may incorporate a method of tubing disconnection such as a crimping 15 or cutting component or method designed to remove all or a part of the device from the process or container to which it is connected or to remove a piece or component of the device from itself.

### REFERENCE SIGNS LIST

1—Motor
2—Base, controls, stand, electrical and other fixed equipment
3—Bead Mill inlet as an aseptic connector
4—Bead Mill outlet as an aseptic connector
5—Agitation discs
6—Milling chamber
7—Primary rotor
8—Single use disc rotor
9—Heat exchange chamber
10—Heat exchange fluid inlet
11—Heat exchange fluid outlet
12—Side A of the single use to re-useable equipment connection
13—Side B of the single use to re-useable equipment connection
14—Tubing
15—Tubing crimp or cut device
16—Tubing connector
17—Positioning groove

1. A device primarily comprised of a single use bead mill;
wherein said device is attached to a process, bioreactor, fermentor or other container by way of tubing, fluid flow components and/or connectors including aseptic connectors and;
wherein at least a portion of the device is sterilized prior to use by irradiation, exposure to ethylene oxide, autoclaving, steaming, use of chemicals or a combination thereof and;
wherein the device is used for cell disruption or homogenization of or within one or more fluid streams in the biopharmaceutical, biotechnology, pharmaceutical or related industries.

2. When the bead mill of claim 1 incorporates a combination of both single use and re-useable components.

3. When the device of claim 1 is connected to a container, fermentor, bioreactor or process by an aseptic connector.

4. When the bead mill of claim 1 incorporates one or more fluid inlets and/or fluid outlets that are aseptic connectors or function as aseptic connectors.

5. When the device of claim 1 is connected to a container, fermentor, bioreactor or process prior to sterilization of the newly formed device or process by irradiation, exposure to ethylene oxide, autoclaving, steaming, use of chemicals or a combination thereof.

6. When the single use components of the device of claim 1 are primarily formed of a polymeric composition.

7. When the device of claim 1 incorporates a method of cutting, crimping or other method of detachment of polymeric tubing that is attached to the device and/or incorporated as part of the device.

8. When the device of claim 1 is wirelessly enabled.

9. When the re-useable portions of the bead mill of claim 1 are attached to the single use portions of the bead mill of claim 1 by a mechanism such as one or more locking tabs, threads or a comparable method used to attach components.

10. When the device of claim 1 is used in conjunction with a previously re-useable bead mill modified to accept single use components consistent with the device of claim 1.
